(19) United States
(12) Patent Application Publication
(10) Pub. No.: US 2013/0142909 A1
(43) Pub. Date: Jun. 6, 2013

(54) EMULSION

(71) Applicant: Sensient Colors Europe GmbH, Geesthacht (DE)

(72) Inventor: Andreas Klingenberg, Reinbek (DE)

(73) Assignee: Sensient Colors Europe GmbH, Geesthacht (DE)

(21) Appl. No.: 13/707,415

(22) Filed: Dec. 6, 2012

(30) Foreign Application Priority Data
Dec. 6, 2011 (DE) 102011056111.0

(51) Int. Cl. A23D 7/00; A23L 2/52

(52) U.S. Cl. CPC A23D 7/003; A23L 2/52
USPC 426/72; 426/602; 426/540; 426/548; 426/311; 426/250; 426/599; 426/615

(57) ABSTRACT

Provided is an emulsion with an aqueous phase and an oil phase including one or more liposoluble components as well as one or more emulsifiers in the aqueous phase, selected from the group of saponins, preferably quillaia extract, and one or more esters of a vegetable lipid with a food acid in the oil phase. The combination of ester(s) and saponin(s) has a particularly advantageous and unexpected effect for emulsions: thus stable emulsions, preferably stable microemulsions are obtained, which have a high acid stability so that the emulsion is in particular suitable for use in very acidic beverages in the range of pH≦3.5. Furthermore, the oxidative stability of the emulsion is improved. If a colorant is emulsified, a premature colorfading can be prevented. In addition, the light stability of the emulsion is increased. The amount of lecithin co-emulsifier in the emulsion can be reduced or this can be completely omitted.

### CROSS-REFERENCE TO RELATED APPLICATIONS

This application claims priority to German Patent Application No. 102011056111.0 filed on Dec. 06, 2011, the entire contents of which are hereby incorporated by reference.

### FIELD

The invention relates to an emulsion, a method for the preparation thereof, the use of the emulsion and a beverage comprising the emulsion.

### BACKGROUND

An emulsion is disclosed in the European Patent No. 1 972 206 B1.

This previously known emulsion comprises an oil phase which is formed from a liposoluble colordispersed in an aqueous phase. The emulsifier comprises an emulsifier composition for emulsification of a liposoluble carotenoidcolorant in a foodstuff which in each case, relative to the weight of the emulsifier composition, comprises between 45 and 55 wt. % of at least one lecithin and between 45 and 55 wt. % of at least one sucrose ester of fatty acids. The fatty acids are in this case selected from the group which comprises palmitic acid, stearic acid, oleic acid, lauric acid and erucic acid. The lecithin is selected from the group consisting of phosphatidylcholine, phosphatidylethanolamine and phosphatidylinositol.

This emulsion known from EP 1 972 206 B1 is characterized in particular in that this has a higher transparency and a better color intensity than known emulsions of food colorants.

EP 2 359 698 A1 further discloses compositions comprising a surface-active system which comprises saponins as well as lecithin. The compositions comprise (i) an aqueous phase comprising water, one, two or more co-solvents selected from the group consisting of propylene glycol, ethanol, triacetin, and glycerol, and optionally one, two or more sugars, preferably selected from the group consisting of sucrose, fructose, and glucose; (ii) a surface-active system comprising one saponin or a mixture of two, three or more saponins, and lecithin, and (iii) an oil phase comprising or consisting of one, two, three or more substances selected from the group consisting of flavorings, vitamins, coloring foodstuffs, and polyunsaturated fatty acids, with the proviso that no polyglycerol fatty acid ester is comprised.

The choice of an emulsifier depends on the properties of the component to be dissolved, the properties of the emulsifier and the framework conditions in which the foodstuff is present. When using liposoluble foodstuff colorants for coloring fruit juices, it should be noted for example that fruit acids can bring about a destruction of the emulsifier. For this reason the use of acid-stable emulsifiers is desirable.

However, most recent studies have shown that the sugar ester used in EP 1 972 206 B1 has only a limited stability in very acidic drinks, for example, below pH 3.5. In addition, it has been shown that the use of the sugar ester does not completely result in the desired approximately transparent and stable coloring.

JP 2006-249037 A discloses a composition comprising moisture ethanol, crushed propolis, saponins, lecithin, polyglycerol fatty acid ester, and sugar powder. This composition is powdered and becomes dispersion when dissolved in water and can be used in beverages.

### SUMMARY

It is therefore the object of the invention to avoid these disadvantages of the prior art. In particular, an emulsion is to be proposed which has a suitable stability, in particular also a high light stability. Furthermore, the emulsion should have a high transparency. In addition, an emulsion is to be provided which has a high acid stability in very acidic drinks, for example, below pH 3.5.

This object is solved by the features of claim 1. Consequently, an emulsion for use in the field of foodstuffs, in particular in a foodstuff, is provided, comprising an aqueous and an oil phase comprising
one or more liposoluble components to be emulsified;
one or more emulsifiers in the aqueous phase selected from the group of saponins; and
one or more esters of a vegetable lipid with a food acid in the oil phase.

Advantageous embodiments of the inventions are manifest in the subclaims.

### DETAILED DESCRIPTION

The invention therefore provides that at least one emulsifier in the aqueous phase is a saponin which, in combination with one or more esters prepared from a vegetable lipid and a food acid, is used for emulsifying one or more liposoluble components and contributes to particularly advantageous properties of the emulsion which is formed.

The component to be emulsified according to the invention is not particularly restricted. It can be any liposoluble compound or a mixture of liposoluble compounds. Preferred components to be emulsified are selected from the group consisting of liposoluble colorants, liposoluble vitamins, essential oils, liposoluble flavorings, extracts and/or concentrates of spices, extracts and/or concen- trates of plants and mixtures of these.

The term “colorant” comprises within the framework of the present invention any type of colorant, preferably a colorant which can and may be used in a foodstuff. The liposoluble colorant is therefore preferably a food colorant. These are particularly preferably carotenoids, for example selected from alpha- or beta-carotene, bixin, capsanthin, capsorubin, lutein, rhodoxanthin, lycopene or apocarotenal; or chlorophyll; or curcuminoids; or mixtures of these. The colorants should also include according to the invention the substance class of “coloring foodstuffs”. These are lipophilic plant extracts and/or concentrates of vegetables such as carrot, capsicum, spinach which have a coloring effect and can therefore be used as part of an emulsion, preferably a microemulsion. Naturally, mixtures of colors can also be used.

The food colorant is preferably a carotenoid. A particularly preferred food colorant is β-carotene. However, according to the invention the colorants are not restricted to food colorants but liposoluble colorants which are not food colorants can also be present in the oil phase.

For emulsification of the liposoluble component, at least one emulsifier selected from the group of saponins is provided in the aqueous phase according to the invention. Those saponins come into question which themselves are either contained as ingredients in foodstuffs and can be obtained therefrom or saponins which are already allowed as food additives. Saponins are glycosides occurring in plants which are of interest on account of their physical-chemical and physiological properties. Saponins are mostly bitter-tasting surface-active compounds which have become known as a result of their importance for soap manufacture (Latin sapo=soap). The aglycone of the saponins consists of a steroid or triterpene moiety to which various sugar molecules are bound. A distinction is therefore made between steroid and triterpene saponins. For example, pulses, spinach, asparagus and oats contain saponins. Saponins are used, for example, in larger quantities in liquorice.

Within the European Community saponin-rich extracts from the bark of the panama or soap bark tree (Quillaia saponaria, so-called Quillaia tree) are licensed as food additives and are used, inter alia as foaming agents. The bark of this tree contains up to 5% saponins. In Germany, quillaia extracts are licensed as an additive for water-based alcohol-free, flavorised refreshing drinks (200 mg/L water-free extract).

The effective surface-active components in quillaia extracts are triterpene saponins which are obtained from the quillaia tree by aqueous extraction methods. A distinction is made here between quillaia extracts of type 1 and type 2. A quillaia extract of type 1 is obtained by aqueous extraction from the comminuted bark or from wood from the quillaia tree and subsequent purification. The total saponin content in the type 1 extract is about 20 to 25%. A type 2 quillaia extract is subjected to additional purification steps such as, for example, an ultra-filtration, membrane filtration or affinity chromatography. The saponin content in the type 2 extract is higher than in type 1 since type 1 is less purified than type 2.

A type 2 quillaia extract is preferably used in the present invention. The total saponin content of the quillaia extract used relative to the dry substance preferably is in the range of 65 to 90% in this case.

Within the framework of the present invention, the “quillaia extract E 999” in a 20% diluted aqueous solution is preferably used as emulsifier.

In addition to the one or more emulsifiers in the aqueous phase, one or more esters of a vegetable lipid with a food acid are used for emulsification of the one or more liposoluble components.

The term “food acid” is to be understood as broadly as possible according to the invention so that any acid which is suitable for human consumption can be used in the present invention.

Food acids which are preferably used according to the invention are selected from hydroxycarboxylic acids suitable for consumption, preferably mono-, di-, tri-, tetra- or polyhydroxycarboxylic acids, or other acids suitable for consumption. Particularly preferred are ascorbic acid, citric acid, acetic acid, tartaric acid, lactic acid, malic acid, mandelic acid, especially preferred are ascorbic and citric acid.

The ester or esters based on a vegetable lipid and a food acid are also not particularly restricted within the framework of the invention. “Vegetable lipid” is understood according to the invention as a water-insoluble or hydrophobic natural substance which occurs in plants. According to the invention, this preferably is mono-, di- and/or triglycerides of edible fatty acids or edible fatty acids (hereinafter designated as “fatty acids”) which can be used as the starting point to produce an ester from this with a food acid. The person skilled in the art is familiar with the preparation of an ester so that, starting from two compounds, he readily either reacts these directly with one another or optionally following appropriate derivatisation, an ester can be prepared in an appropriate manner.

The vegetable lipids which are preferably used according to the invention are saturated fatty acids. Particularly preferred are saturated higher-chain fatty acids. “Higher-chain” is understood according to the invention as a fatty acid which satisfies the following general formula: CH₃—(CH₂)ₓCOOH, where x=8 to 25, preferably 8 to 20, especially preferably 10 to 16. Particularly preferred are lauric acid (x=10), palmitic acid (x=14) or stearic acid (x=16), palmitic acid and stearic acid being especially preferred.

Additionally preferred vegetable lipids are mono- and/or diglycerides of edible fatty acids.

To produce an ester, for example, the OH group of the food acid, e.g. in a hydroxycarboxylic acid suitable for consumption is reacted with the COOH group of the lipid, e.g. a saturated fatty acid, to produce the ester. The ester formation per se is known to the person skilled in the art and is not explained here in detail.

Especially preferred esters of vegetable lipids with food acids which are used according to the invention are ascorbylpalmitate, ascorbylstearate, mono- and/or diglycerides of edible fatty acids with citric acid as well as mixtures of these. Particularly preferred are ascorbylpalmitate and mono- and diglycerides of edible fatty acids with citric acid which are known under the designation “Citrem”. “Citrem” are a group of known citric acid esters of mono- and diglycerides of edible fatty acids and are prepared by chemical reaction from mono- and diglycerides of edible fatty acids and citric acid. These can form oil-in-water emulsions, are known for improving the cohesion of the ingredients in sausage manufacture and due to their complex-forming properties support the effect of anti-oxidants.

It has now been established according to the invention that such esters from vegetable lipid and food acid (hereinafter designated as “ester”) are in a surprising manner capable of stabilizing emulsions, in particular the very severely curved interface of oil-in-water micro-emulsions when at least one saponin is present as an additional emulsifier in the water phase. The combination of ester(s) and saponin(s) therefore has a particularly advantageous and unexpected effect for emulsions.

The use of the saponin(s)/ester(s), preferably quillaia extract/ester combination according to the invention therefore results in the generation of a stable emulsion. preferably a micro-emulsion. A stable interface is also formed in an oil-in-water micro-emulsion. In addition to the stabilization of the emulsion, the oxidative stability of the emulsion is also improved. If the emulsion is used in a beverage, the saponin(s)/ester(s) combination according to the invention ensures in the case of a colorant or a colorant preparation as a component to be emulsified that a premature colorfading in the beverage is prevented.

The saponin(s)/ester(s) combination according to the invention is in particular characterized by a high acid stability in very acidic beverages with a pH in the range of ≦3.5, in particular in the pH range of 2.5 to 3.5.

Furthermore, the saponin(s)/ester(s) combination according to the invention insofar is an efficient system for emulsification of liposoluble components such as food colorants since in particular in beverages, preferably in soft drinks a luminous yellow approximately transparent and stable coloration is achieved.

The saponin(s)/ester(s) combination according to the invention is advantageous insofar as lecithin if contained as a co-emulsifier in the emulsion, can be significantly reduced with regard to the amount used, in individual cases can even be completely omitted.

The term “lecithin” is understood here as a substance according to EC Number E 322 (see Office for Official Publications of the European Community, CONSLEG: 1996L0077-20/11/2003). According to this, lecithin is defined as a mixture or fraction of phosphatides which are obtained by means of physical processes from animal or vegetable foodstuffs. Lecithins also comprise the hydrolysed substances which are obtained with safe and suitable enzymes. The end product must not have any enzymatic residual activity. The terms “phosphatides” and “phospholipids” are used as synonyms for lecithins. The lecithin is preferably selected from the group comprising phosphatidylcholine, phosphatidylethanolamine and phosphatidylinositol. More preferably the lecithin isphosphatidylcholine. According to a further embodiment, the emulsifier composition comprises lecithins according to E 473.

According to the invention, lecithin in the emulsion can be completely replaced. However, there can be cases in which the ester or esters of the vegetable lipids with food acids dissolve less well than lecithin so that the interfaces are more stable if a lecithin residue is still present. Consequently, the complete substitution of lecithin is indeed possible but not advantageous in each case. This can readily be determined in each individual case by the person skilled in the art. Particularly preferably the quantity of added ester(s) replaces approximately the same quantity of lecithin.

In addition to a particularly good stability of the emulsion, in particular in very acidic drinks, an increased light stability could be established. This advantageous effect is attributed to the anti-oxidative protective effect of the ester(s) on the component to be emulsified. This constitutes a decisive advantage in cases where the component to be emulsified is a colorant or a colorant preparation such as carotenoid, since these are exposed to light in beverages for up to 12 months in transparent bottles. It is indeed known to add the water-soluble ascorbic acid to the beverages to protect, for example, carotenoids from fading; however this is only possible to a certain degree since at high doses, the taste properties of the ascorbic acid restrict its use. According to the invention, the addition of esters from vegetable lipids with food acids is superior to the addition of ascorbic acid since the restrictions described regarding the added quantity and disadvantages due to a change in taste do not arise.

The combination of quillaia extract with the ester/s in the form of the anti-oxidant and co-emulsifier ascorbylpalmitate is particularly advantageous. Ascorbylpalmitate, in particular 6-palmitoyl-L-ascorbic acid (E-304), is a known anti-oxidant and an emulsifier and is usually used for stabilizing fat in foodstuffs. As is known, ascorbyl palmitate is principally used in sausage products, mayonnaise and chicken broth.

Ascorbylpalmitate is a fatty acid ester of ascorbic acid, is obtained by esterification of ascorbic acid with palmitic acid and is also designated as palmitic acid ascorbyl ester.

The combination of quillaia extract with a citric acid ester, in particular of mono- and diglycerides of edible fatty acids and citric acid, preferably Citrem, is particularly advantageous.

These embodiments are particularly advantageous according to the invention due to the dual functionality of the esters used, such as ascorbyl palmitate or citric acid esters, which are effective both as co-emulsifier and as anti-oxidative protective substance. Ascorbyl palmitate exhibits an anti-oxidative effect and improves the light stability. When using citric acid esters, the anti-oxidative properties as a result of the complex-forming effects are also of advantage. The emulsions according to the invention, preferably micro-emulsions are therefore particularly well suited for use in acidic beverages and are additionally characterized by good oxidation stability.

The anti-oxidative protective effect can be improved according to the invention by further additives such as ascorbic acid or encapsulating hydrocolloids such as, for example, gum arabic, modified starch.

In addition to the one or more emulsifiers in the form of one or more saponins, preferably quillaia extract, the aqueous phase can contain further components. These are preferably selected from one or more polyols, one or more sugar alcohols, and one or more sugar syrups. Preferred polyols are, for example, propylene glycol and/or glycerol. Preferred sugar alcohols are, for example, glycerol and/or sorbitol. Preferred sugar syrups are, for example, fructose, glucose and/or invert sugar. Naturally, mixtures of these components with one another can also be present in the aqueous phase of the emulsion.

Particularly preferably the aqueous phase comprises at least one polyol and/or at least one sugar alcohol. Particularly preferably the aqueous phase comprises glycerol and/or sorbitol and/or fructose and/or glucose, especially preferably the aqueous phase consists of glycerol and sorbitol and fructose in addition to saponin(s).

Advantageously the aqueous phase also comprises so-called hydrocolloids. Hydrocolloids comprise a large group of compounds which are polysaccharides or proteins which are dissolved as colloids in water and there tend to form gels. Hydrocolloids preferably used are gum arabic, pectin or modified starch. Hydrocolloids are used for stabilizing the valuable ingredients to be emulsified, i.e. the component(s) to be emulsified, against the oxidation thereof. In particular, when used in beverages hydrocolloids have advantages since they not only introduce turbidity into the beverage but at the same time improve the light protection.

Further additives which give the emulsion advantageous properties can be contained in the aqueous phase. For example, ascorbic acid, which is water-soluble, can be added as anti-oxidant to the aqueous phase of the emulsion. As a result, the light and oxidation stability and the microbiological safety of the emulsion is improved.

Vegetable oils are usually contained in the oil phase. Other additives which give the emulsion advantageous properties can also be contained. These are, for example, anti-oxidants such as tocopherol.

The emulsion according to the invention preferably comprises the aqueous phase dispersed in the oil phase where a particularly fine droplet size is present in the oil phase with dissolved ingredients, which preferably comprises a droplet size of 50 to 600 nm, more preferably <200 nm.

As a result of the small droplet size, the emulsion according to the invention has a high transparency. In a preferred embodiment the emulsion is transparent. It can further be provided that the emulsion when used, for example, in beverages, reaches a turbidity coefficient (FNU value) of less than 40 and in a spectro-photometric analysis at 700 nm an absorption coefficient of less than 0.1 is achieved. The FNU value (“Formazine Nephelometric Unit”) is a parameter for the turbidity measurement.

The subject matter of the invention is also the use of the emulsion according to the invention in the field of foodstuffs, in particular in a foodstuff.

The emulsion according to the invention is preferably added to a beverage in a dosage of 0.05 to 2 g/kg of beverage. In this case, a transparent appearance is preferably achieved.

It has proved particularly advantageous according to the invention if so much saponin, preferably type 2 quillaia extract, is added to the end product, in particular a beverage, that a total saponin content in the range of 5 ppm to 15 ppm is present. Such a small content of saponins already has the result that a stable emulsion is obtained, i.e. the resulting emulsion is given a surprisingly high acid stability. This is completely unexpected for the person skilled in the art since, for example, type 1 quillaia extracts are usually used as foaming agents with concentrations of 100 ppm to 250 ppm in soft drinks. According to the invention, significantly lower concentrations compared to this are already sufficient in a beverage in order to obtain a stable emulsion.

According to the invention, preferably the type 2 quillaia extract is present in a concentration of 5 ppm to 50 ppm, more preferably 7.5 ppm to 30 ppm, especially preferably >10 ppm to 25 ppm in a foodstuff, preferably a beverage, especially preferably an acidic beverage.

The ester or esters according to the invention are preferably present in a quantity of 0.5 to 5%. Particularly preferably the amount of ester(s) +lecithin is 0.5 to 5%. A mutual exchangeability is given. Preferably however, the amount of lecithin is significantly smaller compared with the ester and is in the range of 0 to 2%, more preferably 0 to 1.5%, particularly preferably 0.1 to 1%, especially preferably 0.1 to 5%.

Another advantage of the emulsion according to the present invention is that no “ring formation” occurs during storage of beverages colored with the emulsion in PET plastic bottles. This behaviour is also designated as “bottle staining” and “neck ringing effect”. In contrast to the emulsion prepared according to the invention, these disadvantageous effects occur very frequently in known emulsions so that these products are then declined by the consumer. An emulsifier combination of sugar esters and lecithin according to EP 1 972 206 B1, explained initially also has this disadvantage of “ring formation”.

The emulsion preferably comprises (a) 0.5 to 5%, preferably 0.5 to 3% of ester, (b) 0 to 2% of lecithin and (c) 15 to 30% of saponin(s), preferably quillaia extract, where the percentage information relates to the overall formulation of the preparation. Particularly preferably the sum of ester(s) +lecithin is 0.5 to 5%.

When quillaia extract is used, this is a 20% extract dissolved in water.

The emulsion particularly preferably has the following overall formulation:
a) Oil phase

| | |
|---|---|
| ascorbyl palmitate | 0.5% to 5% |
| lecithin | 0% to 2% |
| component to be emulsified | 1.0% to 10% |
| vegetable oil | 2.0% to 20% |
| tocopherol | 1.0% to 3%, |

wherein the total of ascorbyl palmitate +lecithin preferably is in the range of 0.5 to 5%;
b) Water phase:

| | |
|---|---|
| higher alcohol such as glycerol | |
| and/or sugar alcohol such as sorbitol | |
| and/or sugar syrup such as fructose | 40% to 80% |
| saponin(s), preferably quillaia extract | 15% to 30% |

wherein the quillaia extract, in particular a 20% extract, is dissolved in water.

A particularly preferred use of the emulsion according to the present invention is for emulsification of a carotenoid in a fruit beverage or a fruit composition.

Emulsions with a dispersed oil phase whose mean oil droplet size is less than or equal to 200 nm can be prepared by means of high-pressure homogenizers known per se. In this case, a crude emulsion or suspension is conveyed, for example, by means of a triple-piston pump at a pressure of up to 900 bar through a nozzle system. Extreme shear and stretching forces ensure an efficient comminution and a narrow droplet size distribution. A high-turbulence mixing chamber ensures stabilization of the droplets and minimizes coalescence effects. The emulsion according to the invention is preferably prepared at a pressure of 200 to 900 bar.

The invention is explained in detail hereinafter with reference to examples:

Preparation of the Emulsion According to the Invention

To prepare the emulsion according to the invention the following formulation is provided and processed as described hereinafter. The percentage information relate to the overall formulation:

| | Designation | Content |
|---|---|---|
| Water phase | Glycerol | 40.00-80.00% |
| | (higher alcohol) | |
| | Sorbitol | |
| | (sugar alcohol) | |
| | Fructose | |
| | (sugar syrup) | |
| | Quillaia extract | 15.00-30.00% |
| | 20% dissolved in water | |
| Oil phase | Vegetable oil | 2.00-20.00% |
| | Tocopherol | 1-3% |
| | (Antioxidant) | |
| | Ascorbylpalmitate | 0.5-5% |
| | Lecithin | |
| | (co-emulsifier, | |
| | antioxidant) | |
| | Carotene 30% | 1-10% |
| | colorant, | |
| | liposoluble component) | |
| | and/or concentrate of vegetable | |
| | such as carrot | |
| | (lipophilic coloring foodstuff) | |

The quillaia extract is preferably a 20% extract dissolved in water.

1. Preparation of Water Phase

Glycerol, sorbitol and quillaia extract are mixed and heated to 40° C. whilst stirring continuously by means of a laboratory propeller stirrer at about 350 rpm.

2. Preparation of Oil Phase

Tocopherol, vegetable oil, ascorbylpalmitate, optionally lecithin and caroteneare mixed and heated to 140° C. and kept for 5 min whilst stirring continuously. It should be ensured that all the β-carotene crystals are dissolved by monitoring the microscope image (1000×).

3. Preparation of the Emulsion by Addition of Oil in Water

The oil phase is slowly but continuously supplied to the water phase as part of a mixing step whilst dispersing by means of an Ultra-Turrax at 500 rpm. This is followed by a pre-emulsification at 10,000 rpm for 5 min. The particle size distribution and the microscope image of the pre-emulsion are monitored. Here 90% of the particles are to have a size of <1.5 um (target specification: 90.00% <1.5 μm).

This is directly followed by a treatment with the high-pressure homogenizer at450/50 bar in several passes (2-4). The particle size distribution(target specification: 90.00% <1.0 μm) and the microscope image (blank) as well as the turbidity value (c=0.02%→<40 FNU) of the emulsion are then monitored again. The term “microscope image” in the present context is understood as the image in the microscope magnification, i.e. when viewed on the microscope slide on which the (pre-)emulsion was applied, for example at 100 times and/or 1000 times magnification. 4. Evaluation of the Stability

It has been shown that the emulsion according to the invention was stable for 9 months or 5 weeks respectively in storage tests at 5° C. and 40° C. In addition, the particle size measurement and the spectral photometric analyses confirm that the emulsion according to the invention shows no phase separation and remains stable with no indication of color degradation.

1. An emulsion for use in a foodstuff, comprising an aqueous and an oil phase comprising
one or more liposoluble components to be emulsified;
one or more emulsifiers in the aqueous phase selected from the group of saponins; and
one or more esters of a vegetable lipid with a food acid in the oil phase.

2. The emulsion according to claim 1,
characterized in that
the component to be emulsified is selected from the group consisting of liposoluble colorants, liposoluble vitamins, essential oils, liposoluble flavorings, extracts and/or concentrates of spices, extracts and/or concentrates of plants, and mixtures of these.

3. The emulsion according to claim 1 or 2,
characterized in that
the food acid is selected from the group consisting of hydroxycarboxylic acids suitable for consumption, preferably mono-, di-, tri-, tetra- or poly-hydroxycarboxylic acids, or acids suitable for consumption, particularly preferably ascorbic acid, citric acid, acetic acid, tartaric acid, lactic acid, malic acid, mandelic acid, especially preferably ascorbic and citric acid.

4. The emulsion according to any one of the preceding claims,
characterized in that
the vegetable lipids are selected from mono-, di- and/or triglycerides of edible fatty acids or saturated edible fatty acids, preferably lauric acid, palmitic acid, stearic acid or mono- and/or diglycerides of edible fatty acids.

5. The emulsion according to any one of the preceding claims,
characterized in that
the ester or the esters of vegetable lipids with food acids are selected from the group consisting of ascorbylpalmitate, ascorbylstearate, mono- and/ordiglycerides of edible fatty acids with citric acid as well as mixtures of these, preferably ascorbylpalmitateand mono- and diglycerides of edible fatty acids with citric acid (Citrem).

6. The emulsion according to claim 1,
characterized in that
the saponins are quillaia extract, preferably quillaia extract of type 2.

7. The emulsion according to claim 6,
characterized in that
the quillaia extract is a 20% extract dissolved in water.

8. The emulsion according to any one of claims 2 to 7,
characterized in that
the liposoluble colorant is a food colorant, preferably a carotenoid, selected from alpha- or beta-carotene, bixin, capsanthin, capsorubin, lutein, rhodoxanthin, lycopene or apocarotenal; or chlorophyll; or curcuminoids; or is selected from extracts and/or concentrates of vegetable such as carrot, capsicum, spinach or mixtures of these.

9. The emulsion according to any one of the preceding claims,
characterized in that
in the oil phase lecithin is present as emulsifier, preferably in the form of phosphatidylcholine.

10. The emulsion according to claim 9,
characterized in that
the ester or the esters of vegetable lipids with food acids partially or completely replace lecithin as emulsifier in the oil phase, preferably the quantity of ester approximately replaces the same quantity of lecithin.

11. The emulsion according to any one of the preceding claims,
characterized in that
the aqueous phase comprises one or more components selected from one or more polyols, one or more sugar alcohols, one or more sugar syrups, one or more hydrocolloids or mixtures of these, wherein preferably polyols are propylene glycol and glycerol, preferably sugar alcohols are glycerol and sorbitol, preferably sugar syrups are fructose, glucose and invert sugar and preferably hydrocolloids are gum arabic, pectin and modified starch.

12. The emulsion according to any one of the preceding claims,
characterized in that
the emulsion is transparent for light of a wavelength within the visible range for the human eye.

13. The emulsion according to any one of the preceding claims,
characterized in that
the emulsion has an absorption coefficient of less than 0.1 at 700 nm.

14. The emulsion according to any one of the preceding claims,
characterized in that
in addition to quillaia extract dissolved in water, the aqueous phase additionally comprises a higher alcohol such as glycerol and/or a sugar alcohol such as sorbitol and/or sugar syrups such as fructose.

15. The emulsion according to any one of the preceding claims,
characterized in that
the mean size of the oil droplets in the emulsion is 50 nm to 600 nm, preferably<200 nm, more preferably <100 nm.

16. The emulsion according to any one of the preceding claims,
characterized in that
the emulsion comprises
a) 0.5% to 5% of an ester of a vegetable lipid with a food acid;
b) 0%to 2% of lecithin; and
c) 15%to 30% of quillaia extract,
wherein the sum of components a) and b) preferably is in the range of 0.5% to 5%.

17. The emulsion according to any one of the preceding claims,
characterized in that
the emulsion comprises between 40% and 80% of sugar alcohol such as glycerol and/or sorbitol and/or sugar syrup such as fructose and/or glucose.

18. The emulsion according to any one of the preceding claims,
characterized in that
the emulsion has a turbidity coefficient (FNU value) of 40 or less.

19. Method for preparing an emulsion according to any one of the preceding claims,
characterized in that
the emulsion is prepared by means of a high-pressure homogenizer at a pressure of 200 bar to 900 bar.

20. Use of an emulsion according to any one of claims 1 to 18 in the field of foodstuffs, in particular in a foodstuff, particularly preferably for emulsification of a carotenoid in a fruit beverage or a fruit composition.

21. The use according to claim 20, wherein the emulsion is used in a beverage, preferably in an acidic beverage, in particular having a pH of ≦3.5, said beverage preferably comprises 0.05 g/kg to 2 g/kg of the emulsion per kg of beverage.

22. The use according to claim 20,
characterized in that
in the beverage a total content of saponins, preferably contained in the added quillaia extract, is in the range of 5 ppm to 50 ppm, preferably 7.5 ppm to 30 ppm, particularly preferably >10 ppm to 25 ppm, especially preferably 5 ppm to 15 ppm.

23. The emulsion according to any one of the preceding claims 1 to 18, characterized in that
the emulsion has the following overall formulation:
a) Oil phase

| | |
|---|---|
| ascorbylpalmitate | 0.5% to 5% |
| lecithin | 0% to 2% |
| component to be emulsified | 1.0% to 10% |
| vegetable oil | 2.0% to 20% |
| tocopherol | 1.0% to 3%, |

wherein the sum of ascorbylpalmitate and lecithin preferably is in the range of 0.5% to 5%;
b) Water phase:

| | |
|---|---|
| higher alcohol such as glycerol | |
| and/or sugar alcohol such as sorbitol | |
| and/or sugar syrup such as fructose | 40% to 80% |
| saponin(s), preferably quillaia extract | 15% to 30% |

wherein the quillaia extract, in particular a 20% extract, is dissolved in water.

24. Beverage, in particular fruit beverage which preferably is an acidic beverage having a pH of 3.5, in particular 2.5 to 3.5, characterized in that the beverage comprises an emulsion according to one of the preceding claim 1 to 18 or 23.
